(19) United States
(12) Patent Application Publication
(10) Pub. No.: US 2013/0254074 A1
(43) Pub. Date: Sep. 26, 2013

(54) GIFT CARD EXCHANGE MARKETPLACE

(71) Applicants: David JOA, San Bruno, CA (US); Timothy J. BENDEL, Charlotte, NC (US)

(72) Inventors: David JOA, San Bruno, CA (US); Timothy J. BENDEL, Charlotte, NC (US)

(73) Assignee: Bank of America Corporation, Charlotte, NC (US)

(21) Appl. No.: 13/427,763

(22) Filed: Mar. 22, 2012

(51) Int. Cl. G06Q 30/00

(52) U.S. Cl. 705/27.1

(57) ABSTRACT

Systems, apparatus, methods, and computer program products for gift card exchange. The gift card holder is able to exchange either the full purchased amount or a residual balance amount. In other embodiments, a gift card exchange marketplace is provided to allow gift card exchange amongst gift card holders. Thus, gift card exchange alleviates the problem of undesired gift cards (i.e., gift cards from merchants that the recipient does not prefer). Moreover, gift card exchange of residual balances eliminates the problem related to unknown residual gift card balances and keeping track and possession of multiple gift cards with minimal residual balances.

### FIELD

In general, embodiments of the invention relate to commerce and, more particularly, various platforms for gift card exchange.

### BACKGROUND

Many retailers or service providers offer customers the option of purchasing gift cards of a predetermined value, which allow the customer or the individual to whom the gift card is gifted to subsequently purchase merchandise or services from the retailer or service provider named on the gift card using the gift card as the purchase vehicle. Gift cards serve the purpose of allowing the gift card recipient to purchase what he or she desires from the retailer or service provider as opposed to what the gift card giver believes that the gift card recipient may desire, thereby eliminating the need for the gift card recipient to exchange undesired merchandise.

While a gift card recipient (i.e., the giftee) benefits from being able to purchase merchandise or services that they desire, gift cards also pose many problems. In many instances individuals receive retailer-specific or service provider-specific gift cards from retailers or service providers which the gift card recipient does not prefer or does have a need for the merchandise or services provided by the retailer or service provider. In such instances, the gift card recipient is either forced to purchase merchandise or services which they do not desire or need, give the card away to someone who has a use for the merchandise or services provided by the retailer or service provider or, all too often, the gift card goes unused.

In other instances, once a gift card is used either the total value of the card will be applied to the purchase or if the purchase is for less than the value of the gift card a residual balance will remain on the card, which may be applied to subsequent purchases. In such instances in which a residual balance remains on the gift card, the gift card holder is not only burdened with keeping track of the card itself, but also the balance remaining on the card. Such a problem becomes exasperated when the gift holder possesses numerous gift cards from a retailer all of which have, at the least, some residual balance remaining In this scenario, the gift card holder is forced to either keep the numerous gift cards in their possession (i.e., in their wallet or purse) for subsequent use or to remember and locate the numerous gift cards prior to visiting the retailer or service provider. All too often the gift card holder will refuse to keep in their possession numerous gift cards or forget to bring the numerous gift cards to the retailer for redemption. In addition, the gift card holder may be reluctant to redeem numerous cards during a transaction, in which some, if not all, of the gift cards have a trivial residual balance.

Therefore, a need exists to develop options for the gift card holder that will alleviate the problems mentioned above. Specifically, the desired invention should provide the gift card holder with other options in the event that the retailer or service provider associated with a gift card is undesirable or otherwise provides little or no benefit to the gift card holder. In addition, the desired invention should provide the gift card holder with options for overcoming problems related to residual balances remaining on gift cards, such as keeping track of gift cards with residual balances, keeping track of the actual residual balances, keeping track of and possessing numerous cards with residual balances and the like.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, methods, computer program products or the like for the exchange of gift card credit. In embodiments of the invention, a gift card exchange marketplace is created whereby gift card holders can exchange their undesired gift cards they currently possess for other desired gift cards currently held by other gift card holders. In specific embodiments, the gift cards in the marketplace are valued based on their current balance and their supply and demand in the exchange marketplace, such that more readily available gift cards are provided less value in the marketplace while more readily desirable are provided more value.

An apparatus for providing a marketplace for gift card exchange defines first embodiments of the invention. The apparatus includes a computing platform including a memory and a processor in communication with the memory. The apparatus additionally includes a gift card exchange marketplace application stored in the memory and executable by the processor. The gift card exchange marketplace application may be accessible via an Internet website or accessible via another application, such as an online banking application. Mobile banking application or the like.

The application is configured to receive a request from a gift card holder to exchange first gift card(s) issued by a first merchant, wherein the request includes gift card information, such gift card number and, optionally, a PIN. The application is further to determine a current balance amount remaining on the first gift card based on the gift card information and determine one or more gift card exchange options for the gift card holder. Each option includes at least one currently available second gift card issued by a merchant other than the first merchant and a balance amount remaining on the second gift card. The options are determined based on the current balance amount remaining on the first gift card and an exchange rate between the first gift card and the second gift card. The application is further configured to receive a selection from the gift card holder of one of the options and, in response to receiving the selection, validate that the balance amount remaining on the second gift card associated with the selected option is currently available and, in response to validating the balance amount on the second gift card, retaining redemption rights in the exchanged first card and communicating to the gift card holder information associated with the selected second gift card. The communication of the information associated with the second gift card allows the gift card holder to redeem the selected second gift card.

In specific embodiments of the apparatus, the gift card exchange marketplace application is further configured to filter the gift card exchange options based on a current location of the gift card holder, such that only options associated with merchants in the general vicinity of the gift card holder are provided or the options are sorted in terms of their proximity to the current location of the gift card holder.

In other specific embodiments of the apparatus, the gift card exchange marketplace application is further configured to filter the gift card exchange options based on receipt of gift card holder filter criteria. The filter criteria may include, but is not limited to, a preferred location, a preferred merchant, a preferred merchant type, a preferred exchange rate or the like.

In still further specific embodiments of the apparatus, the gift card exchange marketplace application is further configured to determine a dynamic exchange rate between the first gift card and the second gift card based on a current supply and demand of the first gift card and the second gift card within the gift card exchange marketplace. In such embodiments, the exchange rate may dynamically change based on the current supply and demand in the marketplace for the specific gift cards.

In other specific embodiments of the apparatus, the gift card exchange marketplace application is further configured to access a gift card validation network associated with the first merchant to determine the current balance remaining on the first gift card. In such embodiments of the apparatus, the gift card exchange marketplace application may be further configured to access the gift card validation network to validate that the gift card holder is a rightful possessor of the gift card.

A method for exchange of gift cards within a gift card exchange marketplace defines second embodiments of the invention. The method includes receiving a request from a gift card holder to exchange first gift card(s) issued by a first merchant, wherein the request includes gift card information, such as gift card number and, optionally a related PIN. The method further includes determining a current balance amount remaining on the first gift card based on the gift card information and determining one or more gift card exchange options. Each option includes at least one currently available second gift card issued by a merchant other than the first merchant and a balance amount remaining on the second gift card. The options are determined based on the current balance amount remaining on the first gift card and an exchange rate between the first gift card and the second gift card. The method additionally includes receiving a selection from the gift card holder of one of the options and, in response to receiving the selection, validating that the balance amount remaining on the second gift card associated with the selected option is currently available. The method further includes, in response to validating the balance amount on the second gift card, retaining redemption rights in the exchanged first card and communicating to the gift card holder information associated with the selected second gift card.

A computer program product defines third embodiments of the invention. The computer program product includes a non-transitory computer-readable medium having computer-executable instructions. The instructions cause a computer to implement the steps of (1) receiving a request from a gift card holder to exchange at least one first gift card issued by a first merchant, wherein the request includes gift card information, (2) determining a current balance amount remaining on the first gift card based on the gift card information, (3) determining one or more gift card exchange options. Each option includes at least one currently available second gift card issued by a merchant other than the first merchant and a balance amount remaining on the second gift card. The options are determined based on the current balance amount remaining on the first gift card and an exchange rate between the first gift card and the second gift card, (4) receiving a selection from the gift card holder of one of the options, (5) in response to receiving the selection, validating that the balance amount remaining on the second gift card associated with the selected option is currently available and (6) in response to validating the balance amount on the second gift card, retaining redemption rights in the exchanged first card and communicating to the gift card holder information associated with the selected second gift card.

Thus, systems, apparatus, methods, and computer program products herein described in detail below provide for gift card exchange. In certain embodiments, a gift card exchange marketplace may exist to allow gift card exchange amongst gift card holders. By providing for various means of gift card exchange the present invention alleviates the problem of undesired gift cards (i.e., gift cards from merchants that the recipient does not prefer). Moreover, by providing for exchange of residual balances, the present invention eliminates the problem related to unknown residual gift card balances, keeping track and possession of multiple gift cards with minimal residual balances and the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram illustrating an apparatus configured for gift card exchange for financial institution account credit, in accordance with embodiments of the present invention;

FIG. 2 provides a more detailed block diagram of an apparatus configured for gift card exchange for financial institution account credit, in accordance with present embodiments of the invention;

FIG. 3 provides a block diagram illustrating an apparatus configured for providing a marketplace for gift card exchange, in accordance with present embodiments of the invention;

FIG. 4 provides a more detailed block diagram of an apparatus configured for providing a marketplace for gift card exchange, in accordance with embodiments of the present invention;

FIG. 5 provides a flow diagram of a method for gift card exchange for financial institution account, in accordance with embodiments of the present invention; and

FIG. 6 provides a flow diagram of a method for conducting a gift card exchange in gift card marketplace, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for gift card exchange. In certain embodiments either the full issued gift card amount or a residual balance amount (i.e., a balance amount remaining on a gift card after one or more purchases have been made with the card) may be exchanged.

In specific embodiments of the invention, gift card holders are provided the ability to exchange gift card credit for financial institution account credit, such as checking, savings or credit card account credit. In such embodiments the retailers or service providers issuing the gift cards partner with the financial institution such that the retailer or service provider authorizes the financial institution to exchange the gift card credit for the financial institution credit. In transferring the gift card balance amount to the financial institution, the retailer or service partner is compensated or otherwise provide something of value from the financial institution and/or the gift card holders, for example, the retailer or service may be credited a portion, and in some instances all, of the balance remaining in the gift card or the retailer may be compensated in a non-financial manner, such as access to personal or demographic customer data, typically upon approval of the customer.

In other embodiments of the invention, a gift card exchange marketplace is created whereby gift card holders can exchange their undesired gift cards for other desired gift cards. In specific embodiments, the gift cards in the marketplace are valued based on their current balance and their supply and demand in the exchange marketplace, such that more readily available gift cards are provided less value in the marketplace while more readily desirable are provided more value.

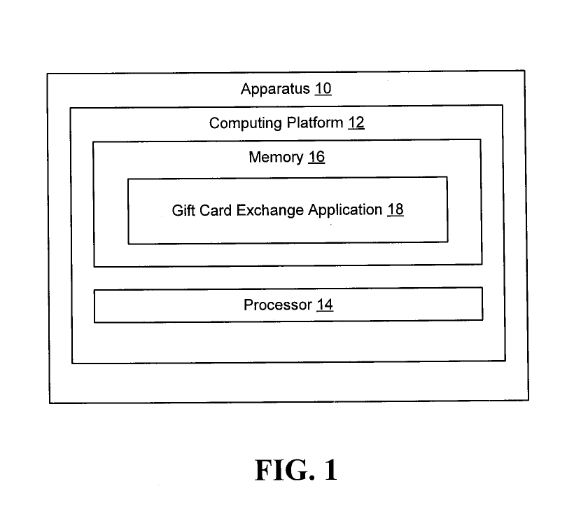

Referring to FIG. 1 a block diagram is depicted of an apparatus 10 configured to provide exchange of gift card credit for financial institution account credit, in accordance with embodiments of the present invention. The apparatus 10 includes a computing platform 12 having a memory 16 and a processor 14 in communication with the memory 16. Apparatus 10, as defined herein may include more than one computing device, such as multiple servers, data storage devices and the like.

Memory 16 of apparatus 10 stores gift card exchange application 18, which is configured to provide gift card balance exchange for financial institution account credit, such as checking/Demand Deposit Account (DDA), savings, credit account credit or the like. The gift card exchange application 18 may be accessible to financial institution customer, or in some embodiments, non-customers, through a financial institution platform, such as online banking, mobile banking, an Automated Teller Machine, a call center, a banking center or the like. In other embodiments of the invention the gift card exchange application may be a stand-alone application accessible to financial institution customers or non-customers outside of a financial institution platform, such as a stand-alone Internet website or the like. In those embodiments in which the financial institution customer is a non-customer, the non-customer may be required to open a financial institution account in conjunction with exchanging the gift card balance.

The gift card exchange application 18 is configured to receive gift card information from a user (e.g., a financial institution customer or, in some embodiments, a non-customer). The gift card information, which may include the gift card number and, in some embodiments the gift card Personal Identification Number (PIN), may be associated with a single gift card or multiple gift cards. As previously noted the financial institution customer (i.e., gift card holder) may in possession of multiple gift cards which they desire to exchange for financial institution credit, for example, the financial institution customer may have multiple cards from the same retailer/merchant all of which have some residual balance remaining on the card.

The gift card exchange application 18 is further configured to determine or verify the balance amount remaining on the one or more gift cards based on the gift card information. In this regard, the gift card exchange application 18 may be configured to access the gift card verification network associated with the card issuing merchant/retailer or service provider to determine the outstanding balance on the gift card. In this regard it is not necessary for the financial institution customer/gift card holder to know what the balance is on the card and/or to input the balance when requesting an exchange, since the gift card exchange application 18 will be required to determine/verify the balance amount remaining on the gift card prior to providing the financial institution customer gift card exchange offers.

In specific embodiments of the invention, the balance amount remaining on the gift card(s) may determine whether exchange of the balance amount for financial institution credit is possible. For example, the financial institution and/or the gift card issuing merchant/retailer or service provider may limit gift card balance exchange to balance amounts at or below a certain predetermined threshold, balance amount percentage in comparison to the full gift card amount at or below a certain predetermined threshold or the like. In other embodiments of the invention, the financial institution and/or the gift card issuing merchant/retailer or service provider may allow for exchange of any gift card balance including in some embodiments the full gift card amount (i.e., the amount the card was issued for).

Further, the gift card exchange application 18 is configured to identify one or more exchange rates for the balance remaining on the gift card(s). As described in greater detail infra. the exchange rate may be defined by the gift card issuing merchant/retailer or service provider, the financial institution or a combination of both. In this regard, the exchange rate may be based on (1) which merchant/retailer/service provider issued the gift card, (2) the balance remaining on the gift cards (i.e., higher or lower exchange rates may be applied based on the amount of the balance remaining or the percentage of the balance remaining in comparison to the full amount), (3) the type of financial institution to which the credit will issued (e.g., higher exchange rate for savings account credit, lower exchange rate for credit card account credit or the like) or the like. In specific embodiments the exchange rate may be one-to-one (1:1), such that the financial institution customer/gift card holder is provided financial institution account credit that is equal to the balance remaining on the gift card(s). In other specific embodiments the exchange rate is less than one-to-one (1:1).

In addition, gift card exchange application 18 is configured to provide the financial institution customer one or more offers to exchange the balance amount for an exchange amount to be credited to a financial institution account. The exchange amount in the offers is based on the balance amount remaining on the gift card(s) and the identified exchange rate(s). While in many embodiments only one offer will be presented to the financial institution customer, in other embodiments more than one offer is provided, for example, different offers having different exchange amounts based on different exchange rates associated with different financial institution accounts. For example, as described above, one offer may be associated with crediting a savings account and another offer may be associated with crediting a credit card account and the two offers have different exchange amounts due to the difference in exchange rates associated with the different financial institution accounts.

Lastly, the gift card exchange application 19 is configured, in response to a financial institution customer accepting one of the offers, to automatically credit the financial institution account associated with the selected offer, such that the crediting reflects the exchange amount in the offer.

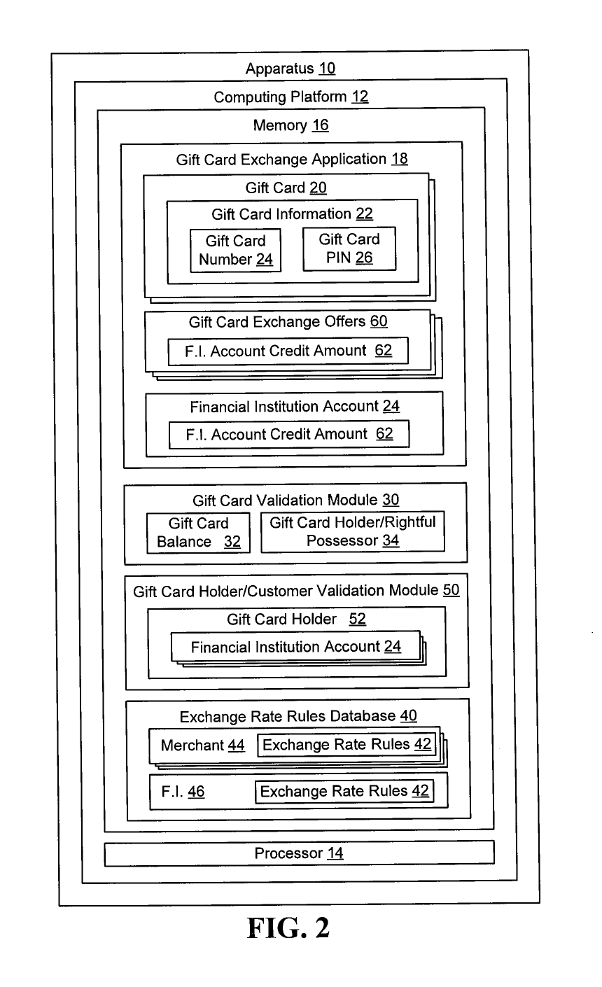

Referring to FIG. 2 a more detailed block diagram is presented of an apparatus configured to provide exchange of gift card credit for financial institution account credit, in accordance with embodiments of the present invention. In addition to providing greater detail, FIG. 2 highlights various alternate embodiments of the apparatus. The apparatus 10 may include any type and/or combination of one or more computing devices, such as a server, storage device or the like. The computer platform 12 is operable to receive and execute modules, routines and applications, such as gift card exchange application 18, gift card validation module 30 and gift card holder/customer validation module 40 and the like.

Computer platform 12 includes memory 16, which may comprise volatile and nonvolatile memory such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computer platform 12 also includes processor 14, which may be an application-specific integrated circuit (“ASIC”), or other chipset, processor, logic circuit, or other data processing device. Processor 14 or other processor such as ASIC may execute an application programming interface (“API”) layer (not shown in FIG. 2) that interfaces with any resident programs, such as gift card exchange application 18, gift card validation module 30 and gift card holder/customer validation module 40 or the like, stored in the memory 16 of apparatus 10. Processor 14 includes various processing subsystems (not Shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include the functionality of gift card exchange application 18, gift card validation module 30 and gift card holder/customer validation module 40 obviating the need for such applications and modules to be stored in the memory.

As previously described in relation to FIG. 1, memory 16 stores gift card exchange application 18 that is configured to exchange gift card balances for financial institution account credit, such as checking/Demand Deposit Account (DDA), savings, credit account credit or the like. Merchants, retailers, service providers or the like that issue gift cards will have previously agreed to participate in a program whereby they have agreed to allow for balances on their gift cards to be converted to financial institution credit. Such tacit agreement to participate in the program is necessary since the balance remaining on the gift cards needs to be transferred to the financial institution upon exchange of gift card balance. Thus, when the financial institution customer/gift card holder accesses the application, the financial institution customer/gift card holder is presented with a listing of the merchants, retailers or service providers participating in the program to determine if the gift cards the possess are eligible for exchange.

In optional embodiments the memory 16 of apparatus 10 may store gift card holder/customer validation module 50 that is configured to validate the financial institution customer/gift card holder 52 as being associated with at least one financial institution account 24. Association with a financial institution account may include the gift card holder 52 being the named individual or party on the account 24 or otherwise authorized to make deposits into the account 24. The card holder/customer validation module 40 may be configured as the financial institution customer authorization for online or mobile banking, ATM authorization or some other user authorization/validation which serves to associate the financial institution customer with financial institution accounts. The gift card holder/customer validation module 40 may be implemented prior to providing the financial institution customer/gift card holder 52 access to the gift card exchange application 18 or at any point during the exchange prior to crediting the financial account 24 with the exchange amount.

The gift card exchange application 18 is configured to receive, from a financial institution customer (i.e., a gift card holder), gift card information 22 associated with one or more gift cards 20. The gift card information 22 may include the gift card number 24 and, in some embodiments, the gift card Personal Identification Number (PIN) 26, as well as any other information necessary to confirm the credit balance on the gift card.

The memory 16 of apparatus 10 additionally stores gift card validation module 30 which is configured to determine or verify the balance amount remaining on the one or more gift cards being requested for exchange based on the gift card information. In this regard the gift card validation module 30 is configured to access the various gift card verification networks (not shown in FIG. 2) associated with the card issuing merchant/retailer or service provider to determine the gift card balance 32 and, in some embodiments, verify that the financial institution customer/gift card holder is the rightful possessor 34 of the gift card. Such verification may be implemented by providing the gift card information 22, such as the gift card number 24 and the gift card PIN 26 to the gift card verification network to validate the gift card balance 32 and rightful possession 34 of the gift card 34. In addition to validating gift card balance 32 and rightful possession 34, communication with the gift card verification network may additional provide for placing a temporary hold on the use of the gift card balance while the financial institution customer is contemplating exchanging the card for gift card credit, so as to prevent simultaneous use and exchange of the gift card balance.

The gift card exchange application 18 is additionally in communication with exchange rate rules database 40 which stores merchant exchange rate rules 32 for the various merchants. Once the gift card exchange application 18 has determined/verified gift card balance, the application 18 identifies one or more exchange rates 42 for the balance amount remaining on the gift card(s). The exchange rate may be defined by exchange rate rules 42 associated with the gift card issuing merchant/retailer or service provider 44, the financial institution 46 or a combination of both. For example, each gift card issuing merchant/retailer or service provider 44 may define an exchange rate or the rules for exchange rates 42 or, in other embodiments, the financial institution 46 may define an exchange rate or the rules for exchange rates 42. In instance in which both the merchant 44 and financial institution 46 have defined exchange rate rules 42 a predetermined rules priority may be defined for determining which exchange rate rules apply.

As previously noted exchange rate rules 42 may define a predetermined specific exchange rate for each merchant 44 participating in the program. In other instances each merchant 44 or the financial institution 46 may define rules 42 based on the balance remaining on the gift cards (i.e., higher or lower exchange rates may be applied based on the amount of the balance remaining or the percentage of the balance remaining in comparison to the full amount). In other instances, the financial institution 46 may define rules 42 based the type of financial institution to which the credit will issued (e.g., higher exchange rate for savings account credit, lower exchange rate for credit card account credit or the like) or the like.

Once the gift card exchange rate(s) has been identified it is applied to the gift card balance 32 to provide for one or more gift card exchange offers 60 to exchange the balance amount 32 for an exchange amount 62 to be credited to a financial institution account 24. As previously noted, while in many embodiments only one offer 60 will be presented to the financial institution customer, in other embodiments more than one offer 60 is provided, for example, different offers 60 having different exchange amounts 62 based on different exchange rates associated with different financial institution accounts 24. For example, as described above, one offer 60 may be associated with crediting a savings account and another offer 60 may be associated with crediting a credit card account and the two offers have different exchange amounts due to the difference in exchange rates associated with the different financial institution accounts 24.

The gift card exchange application 19 is additionally configured, in response to a financial institution customer/gift card holder 42 accepting one of the offers 60, to automatically credit the financial institution account 24 associated with the selected offer 60, such that the crediting reflects the account credit amount 62 in the offer 60.

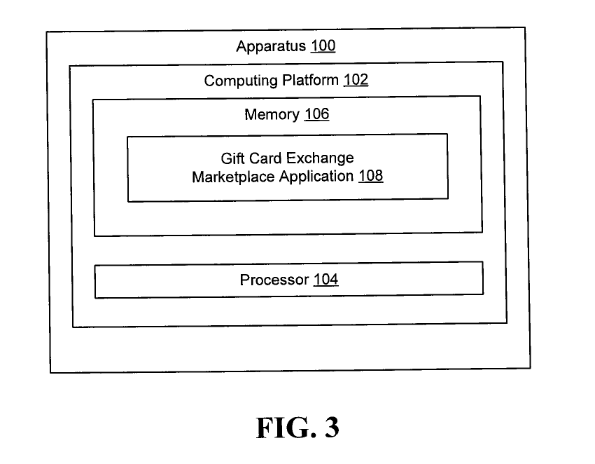

Referring to FIG. 3 a block diagram is depicted of an apparatus 100 configured for providing a marketplace for gift card exchange, in accordance with alternate embodiments of the present invention. As previously noted, the marketplace concept allows gift card holders to exchange their undesired gift cards for other gift cards existing in the virtual marketplace. The apparatus 100 includes a computing platform 102 having a memory 106 and a processor 104 in communication with the memory 106. Apparatus 100, as defined herein may include more than one computing device, such as multiple servers, data storage devices and the like.

Memory 106 of apparatus 100 stores gift card exchange marketplace application 108, which is configured to provide a marketplace for gift card exchange. The gift card exchange marketplace application 18 may be accessible may be configured to be an Internet-based application that is accessible to all gift card holders or a certain predetermined segment of gift card holders, such as those gift card holders that customers of a specific financial institution or the like.

The gift card exchange marketplace application 108 is configured to receive a request from a gift card holder to exchange at least one gift card issued by a first merchant or service provider. The request to exchange the gift card(s) includes gift card information, such as the gift card number and, in some embodiments the gift card Personal Identification Number (PIN).

The gift card exchange marketplace application 108 is further configured to determine or verify the balance amount remaining on the one or more gift cards based on the gift card information. In this regard, the gift card exchange application 18 may be configured to access the gift card verification network associated with the card issuing merchant/retailer or service provider to determine the outstanding balance on the gift card. In this regard it is not necessary for the financial institution customer/gift card holder to know what the balance is on the card and/or to input the balance when requesting an exchange, since the gift card exchange marketplace application 108 will be required to determine/verify the balance amount remaining on the gift card prior to providing the financial institution customer gift card exchange options.

Further, the gift card exchange marketplace application 108 is further configured to determine one or more gift card exchange options for the gift card holder. Each gift card exchange option includes at least one available gift card issued by a merchant other than the merchant that issued the card currently held by the gift card holder and the balance amount remaining on the available gift card. The gift card exchange options are determined based on the balance verified in the gift card(s) requested for exchange and an exchange rate between the gift card(s) requested for exchange and the gift card(s) in the exchange option. In specific embodiments of the invention, the exchange rate may be a one-to-one (1:1) exchange rate in which the balance verified in the gift cards(s) requested for exchange is equal in amount to the gift cards in the exchange option. However, in other embodiments of the invention, supply and demand of specific gift card(s), as defined by the issuing entity, may dictate a dynamic exchange rate that fluctuates depending on the current supply of gift cards available in the marketplace from a specific card-issuing retailer/service provider and/or the current demand for gift cards in the marketplace from a specific card-issuing retailer/service provider.

The gift card exchange marketplace application 108 is further configured to receive a selection, from the gift card holder, of one of the gift card exchange options. In response to receiving the selection, the marketplace application 108 is further configured validate that the balance amount in the gift card(s) included in the selected option is currently available and the same balance as purported in the exchange offer. The virtual nature of the marketplace means that gift card holders that exchange their gift cards into the marketplace may still possess or have knowledge of the information associated with their exchanged gift cards. Such gift card information, for example, the gift card number and PIN, allows the gift card holder to redeem the gift card even though they have exchanged the gift card in the marketplace. Thus, the marketplace must validate that the balance amount on the gift card(s) in the selected exchange option is currently available and is the same amount as in the gift card exchange option. In this regard, the gift card exchange marketplace application 108 may be configured to access the gift card verification network associated with the card issuing merchant/retailer or service provider to determine the outstanding balance on the gift card(s) in the selected exchange option. The validation of the gift cards(s) in the selected exchange option is shown and described as occurring after the selection of the exchange option to provide the best assurance of the current balance in those gift cards. However, it is also possible and within the inventive concepts herein disclosed to validate the current available amount in the gift cards prior to, or as part of, determining the one or more gift card exchange options.

Lastly, the gift card exchange marketplace application is configured to retain redemption rights in the exchanged gift card(s) and communicate to the gift card holder the information associated with the gift card(s) in the selected option, such that the information communicated, such as the gift card number and PIN, allows the gift holder to redeem the gift card(s) in the selected option. Further, the gift card(s) which the gift holder exchanged are placed into the marketplace for subsequent gift card exchange options for other gift card holders requesting exchange.

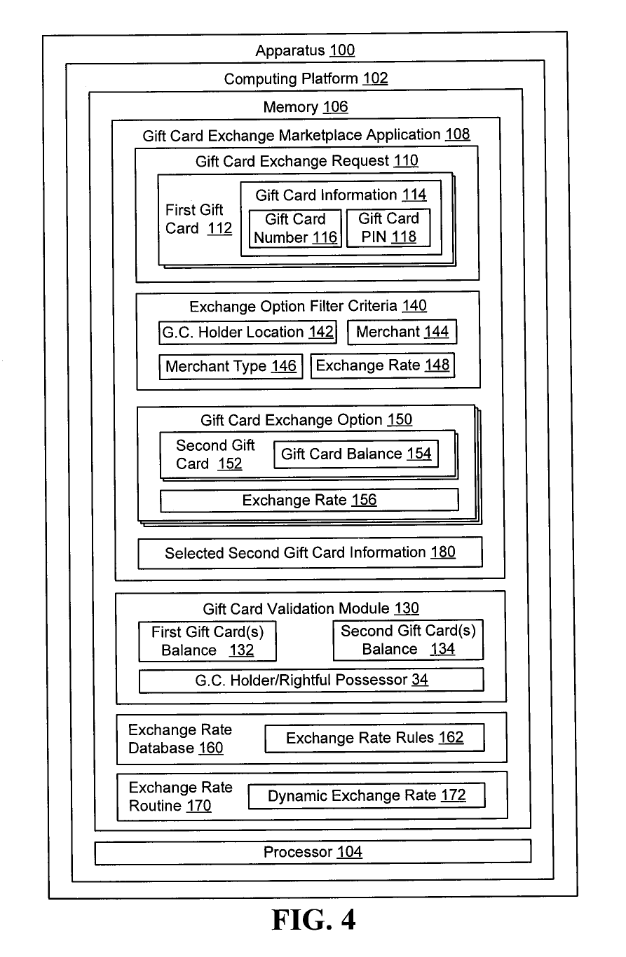

Turning the reader's attention to FIG. 4 a more detailed block diagram is presented of an apparatus configured to provide a marketplace for gift card exchange, in accordance with embodiments of the present invention. In addition to providing greater detail, FIG. 4 highlights various alternate embodiments of the apparatus. The apparatus 100 may include any type and/or combination of one or more computing devices, such as a server, storage device or the like. The computer platform 102 is operable to receive and execute modules, routines and applications, such as gift card exchange marketplace application 18, gift card validation module 130 and exchange rate routine 170 and the like.

Computer platform 102 includes memory 106, which may comprise volatile and nonvolatile memory such as read-only and/or random-access memory (RAM and ROM), EPROM, EEPROM, flash cards, or any memory common to computer platforms. Further, memory 106 may include one or more flash memory cells, or may be any secondary or tertiary storage device, such as magnetic media, optical media, tape, or soft or hard disk.

Further, computer platform 102 also includes processor 104, which may be an application-specific integrated circuit (“ASIC”), or other chipset, processor, logic circuit, or other data processing device. Processor 104 or other processor such as ASIC may execute an application programming interface (“API”) layer (not shown in FIG. 2) that interfaces with any resident programs, such as gift card exchange marketplace application 108, gift card validation module 130 and exchange rate routine 170 or the like, stored in the memory 106 of apparatus 100. Processor 104 includes various processing subsystems (not shown in FIG. 2) embodied in hardware, firmware, software, and combinations thereof, that enable the functionality of apparatus 100 and the operability of the apparatus on a network. For example, processing subsystems allow for initiating and maintaining communications, and exchanging data, with other networked devices. Additionally, processing subsystems may include the functionality of gift card exchange marketplace application 108, gift card validation module 130 and exchange rate routine 170 obviating the need for such applications and modules to be stored in the memory.

As previously described in relation to FIG. 3, memory 106 stores gift card exchange marketplace application 108 that is configured to provide gift card holders the ability to exchange one gift card(s) for another gift card(s).

The gift card exchange marketplace application 108 is configured to receive, from a gift card holder, a gift card exchange request 110 to exchange at least one first gift card 112 issued by a first merchant or service provider. The request includes gift card information 114 associated with one or more first gift cards 112. The gift card information 114 may include the gift card number 116 and, in some embodiments, the gift card Personal Identification Number (PIN) 118, as well as any other information necessary to confirm the credit balance on the gift card.

The memory 106 of apparatus 100 additionally stores gift card validation module 130 which is configured to determine or verify the balance amount 132 remaining on the one or more first gift cards 112. In this regard the gift card validation module 130 is configured to access the various gift card verification networks (not shown in FIG. 4) associated with the card issuing merchant/retailer or service provider to determine the gift card balance 132 and, in some embodiments, verify that the financial institution customer/gift card holder is the rightful possessor 134 of the gift card. Such verification may be implemented by providing the gift card information 114, such as the gift card number 116 and the gift card PIN 118 to the gift card verification network to validate the first gift card balance 132 and rightful possession 134 of the first gift card 112.

In optional embodiments, the gift card exchange marketplace application 18 is configured to receive exchange option filter criteria 140. The filter criteria is used to by the marketplace application 108 to provide the gift card holder with exchange options 150 that may be of interest to the gift card holder. In certain embodiments of the invention the filter criteria 140 may include the current location 142 of the gift card holder. The current location 142 may be inputted into the application by the gift card holder or the current location may be automatically determined by a location-determining device (not shown in FIG. 4), such as a GPS device or the like, which may be included in the device accessing the marketplace application 108, such as a mobile device or the like. The current location 142 of the gift card holder provides for gift card exchange options 150 to be presented to the card holder in which the gift card issuer associated with the gift cards in the exchange option 150 are currently close in physical proximity to the gift card holder. In specific embodiments, the gift card exchange options may be presented in ranked in order of the closest in proximity gift issuer. In other embodiments of the invention the exchange option filter criteria 140 may be gift card holder-defined and include, but is not limited to, a specific merchant/service provider 144, a specific merchant type 146, best exchange rate 148 or any other filter criteria which serves to provide the gift card holder with exchange options 150 that may be of interest.

The gift card exchange marketplace application 108 is further configured to determine and present one or more gift card exchange options 150 for the gift card holder. Each option includes one or more second gift cards 152 issued by a second merchant or service provider (different from the first merchant) and a balance remaining 154 on the second gift card(s). The options are determined based on the balance remaining 132 in the first gift card(s) 112, an exchange rate 156 between the first 112 and second gift card(s) 152 and, optionally, the exchange option filter criteria 140.

As such, the memory 106 of apparatus 100 stores exchange rate database 160 which is configured to store one or more exchange rate rules 162 used to determine exchange rate 156. The exchange rate rules 162 may be marketplace entity-defined rules, merchant/service provider-defined rules, gift card holder-defined rules or a combination thereof. In specific embodiments of the invention, the memory 106 of apparatus 100 may store exchange rate routine 170 that is configured to determine a dynamic exchange rate 172 based on the current supply and/or demand of the first gift cards and the second gift cards within the marketplace.

The gift card exchange application 19 is additionally configured to receive a selection of a gift card exchange option 152 from the gift card holder and, in response to receiving the selection, validate/determine the current balance 134 on the second gift cards 152 in the selected option. As previously noted, validation of the current balance 134 on the second gift cards 152 at the time of exchange is necessary to ensure that the balance at the time of a previous exchange is the same as the current balance (i.e., that the previous exchanger has not redeemed the balance). Additionally, as previously noted validation of validation of the current balance 134 on the second gift cards 152 may occur during the determination of the exchange options 150 or prior to presenting the exchange options 150 to the gift card holder.

In response to validating the second gift card(s), redemption rights in the first gift card(s) are retained to the marketplace and second gift card information 180, such as gift card number and PIN, is communicated to the gift card holder. The gift card information 180 empowers the gift card holder with the ability to redeem the balance remaining 134 on the second gift card 152.

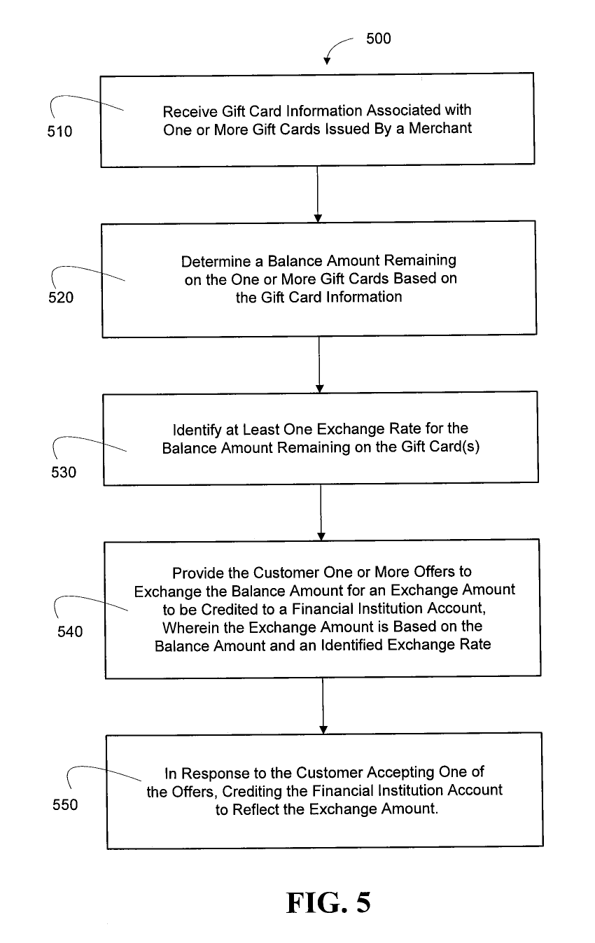

FIG. 5 depicts a flow diagram of a method 500 for exchanging gift card credit for financial institution account credit, according to embodiments of the present invention. At Event 510, gift card information is received from a financial institution customer. The gift card information is associated with one or more gift cards issued by one or more merchants. The gift card information, which may include a gift card number and a gift card PIN may be received at any financial institution platform capable of gift card exchange, including but not limited to, a mobile bank application, an online banking application, an Automated Teller Machine (ATM), a call center, a manually at a banking center or the like. Prior to receiving the gift card information the customer may be authenticated to verify that the customer is associated with or otherwise authorized to make deposits into one or more financial accounts at the financial institution.

At Event 520, a balance amount remaining on the one or more gift cards is determined based on the gift card information. In this regard, the financial institution communicates with the gift card validation network associated with the gift card issuer and provides the gift card number and, optionally the PIN to determine the remaining balance on the gift cards.

At Event 530, at least one exchange rate is identified for the balance remaining on the gift card. In specific embodiments the exchange rate may be based on an agreement between the merchant issuing the gift card and the financial institution. For example, in certain embodiments, the exchange rate may be one-to-one (1:1) allowing for the gift card holder to exchange the entire gift balance for the equivalent financial institution account credit, while in other embodiments the exchange rate may be less than one-to-one (1:1). In certain embodiments of the invention the exchange rate may vary depending on the balancing remaining on the gift cards, in terms of actual balance or the percentage remaining in comparison to the full issued gift card amount. In still further embodiments of the method, the exchange may vary depending on the type of financial institution account to which the gift holder desires account credit or the type of financial account to which the financial institution is willing to provide credit. For example, credit to a savings account may have a higher exchange rate than credit to a credit card account or the like.

At Event 540, the gift card holder is provided one or more offers to exchange the balance amount for an exchange amount to be credited to a financial institution account. The exchange amount is based applying the identified exchange rate to the balance amount remaining on the gift card(s). In most instances, in which only one exchange rate is applicable to the gift card exchange, the customer is provided one offer to exchange the remaining balance for financial institution account credit. However, in other instances more than one offer may be provided; for example, if the type of financial institution account to which the credit is applied varies in terms of exchange rate, more than one offer may be provided.

At Event 550, in response to the customer accepting one of the offers, the financial institution account associated with the offer is credited to reflect the exchange amount in the offer.

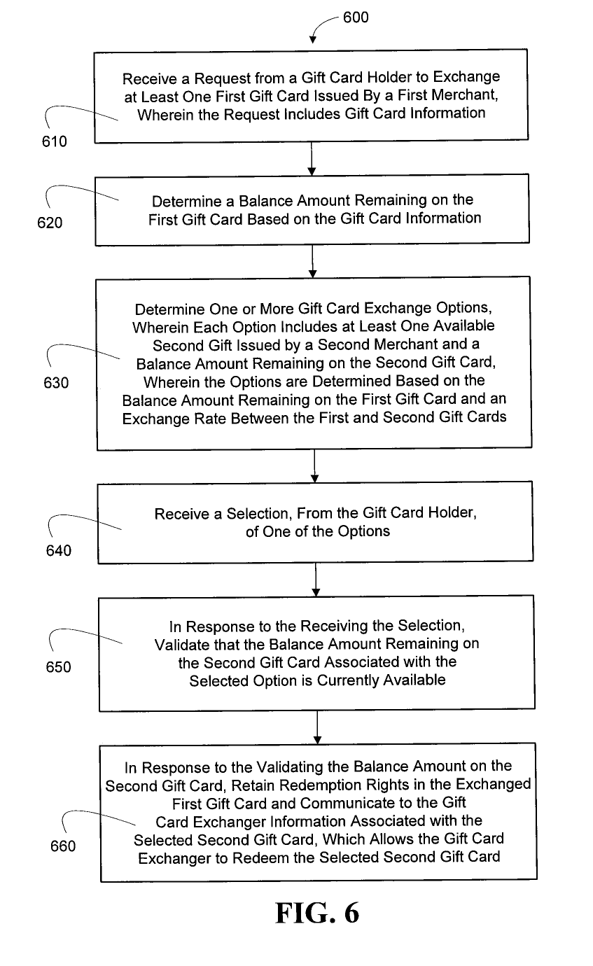

Referring to FIG. 6 a flow diagram is presented of a method 600 for providing a marketplace for gift card exchange, in accordance with embodiments of the present invention. As previously noted the marketplace may be provided as an inclusive Internet-based application/service, accessible to all gift card holders, or it may be provided as an exclusive Internet-based or Intranet-based application/service, accessible to only a portion of gift card holders, for example financial institution customers.

At Event 610 a request or inquiry is received from a gift card holder to exchange at least one first gift card issued by a merchant or service provider. The gift card information includes a gift card number and, optionally, a gift card PIN.

At Event 620, a balance amount remaining on the first gift card(s) is determined based on the gift card information. In this regard, the financial institution communicates with the gift card validation network associated with the gift card issuer and provides the gift card number and, optionally, the gift card PIN to determine the remaining balance on the gift cards. It should be noted that while the marketplace providing entity and card issuer need not be in agreement/relationship concerning the exchange of cards, the marketplace providing entity at least needs to be communication with the gift card validation network in order to validate/determine current gift card balances.

At Event 630, one or more gift card exchange options are determined and provided to the gift card holder. The gift card exchange options include at least one available second gift issued by a second merchant and a balance amount remaining on the second gift card(s). The exchange options are determined based on the balance remaining on the first gift card(s) and an exchange rate between the first and second gift cards. The exchange may provide for a one-to-one (1:1) exchange rate whereby the balance amount remaining on the second gift card is equivalent, or nearly equivalent, to the current balance remaining on the first gift cards(s). While in other embodiments the exchange rate be less than or greater than one-to-one (1:1). In such embodiments in which the exchange rate is less than or greater than one-to-one (1:1) the exchange rate may be dynamically determined based on the supply and demand for the first and second gift cards. Additionally, it is feasible to configure the exchange offers to include a payment amount in the event the second gift card(s) are valued above the first gift card(s) or a rebate amount (which may be configured as a cash payout or financial institution credit) in the event the second gift card(s) are valued less than the first gift card(s).

In alternate embodiments of the method, prior to providing the gift card holder the exchange options, the options may be filtered such that only those options that meet the filter criteria are presented to the gift card holder or the options are presented in an order which reflects the most criteria met. For example, the exchange options may be filtered based on the current location of the gift card holder, such that the exchange options that are closest in proximity to the gift card holder are presented first. The current location of the gift card holder may be manually inputted by the gift card holder or automatically determined by location-determining means, such as Global Positioning System (GPS) or the like. In other instances, the gift card holder may define the filter criteria, such as specific merchant, a merchant type, product type, best exchange rate or the like. In such instances the exchange options presented may be those that meet the criteria or are presented in ranked ordered according to criteria met.

At Event 640, a selection of one of the gift card exchange options is received from the gift card holder. At Event 650, in response to receiving the selection, a balance amount remaining on the second gift card(s) is validated/determined. In this regard, the financial institution communicates with the gift card validation network associated with the second gift card issuer and provides the gift card number and, optionally, the gift card PIN to determine the remaining balance on the second gift cards. Second gift card validation is shown as occurring after the gift card holder selects an option to insure that the balance remaining on the second gift card is equivalent to the balance in the offer. However, in other embodiments, second gift validation may occur prior to determining and providing the gift card exchange options to the gift card holder. As previously noted second gift card validation is necessary to insure that the gift card holder that placed the second gift cards in the marketplace has not redeemed the credit after exchanging the second gift cards to the marketplace.

At Event 660, in response to validating the balance amount on the second gift cards, redemption rights in the first gift card(s) are retained and gift card information associated with the second gift cards (e.g., gift card number(s) and, optionally PIN(s)) are communicated to the gift card holder. The communication of the second gift card information allows the gift card holder to redeem the second gift card(s) at his or her discretion.

Thus, systems, apparatus, methods, and computer program products described above provide for gift card exchange. In certain embodiments either the full gift card amount or a residual balance amount may be exchanged. In specific embodiments, a gift card exchange marketplace may exist to allow gift card exchange amongst gift card holders. By providing for various different means of gift card exchange the present invention alleviates the problem of undesired gift cards (i.e., gift cards from merchants that the recipient does not prefer). In addition, by providing for exchange of residual balances, the present invention eliminates the problem related to unknown residual gift card balances, keeping track and possession of multiple gift cards with minimal residual balances and the like.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for providing a marketplace for gift card exchange, the apparatus comprising:
a computing platform including a memory and a processor in communication with the memory;
a gift card exchange marketplace application stored in the memory, executable by the processor and configured to:
receive a request from a gift card holder to exchange at least one first gift card issued by a first merchant, wherein the request includes gift card information;
determine a balance amount remaining on the first gift card based on the gift card information;
determine one or more gift card exchange options for the gift card holder, wherein each option includes at least one available second gift card issued by a merchant other than the first merchant and a balance amount remaining on the second gift card, wherein the options are determined based on the balance amount remaining on the first gift card and an exchange rate between the first gift card and the second gift card;
receive a selection from the gift card holder of one of the options;
in response to receiving the selection, validate that the balance amount remaining on the second gift card associated with the selected option is currently available; and
in response to validating the balance amount on the second gift card, retaining redemption rights in the exchanged first card and communicating, to the gift card holder information, associated with the selected second gift card, which allows the gift card holder to redeem the selected second gift card.

2. The apparatus of claim 1, wherein the gift card exchange marketplace application is further configured to filter the gift card exchange options based on a current location of the gift card holder.

3. The apparatus of claim 1, wherein the gift card exchange marketplace application is further configured to filter the gift card exchange options based on receipt of gift card holder filter criteria.

4. The apparatus of claim 3, wherein the gift card exchange marketplace application is further configured to filter the gift card exchange options based on receipt of gift card holder filter criteria, wherein the criteria includes at least one of a preferred merchant, a preferred merchant type, or maximizing exchange rate.

5. The apparatus of claim 1, wherein the gift card exchange marketplace application is further configured to determine a dynamic exchange rate between the first gift card and the second gift card based on a current supply and demand of the first gift card and the second gift card within the gift card exchange marketplace.

6. The apparatus of claim 1, wherein the gift card exchange marketplace application is further configured to access a gift card validation network associated with the first merchant to determine the balance remaining on the first gift card.

7. The apparatus of claim 6, wherein the gift card exchange marketplace application is further configured to access the gift card validation network to validate that the gift card holder is a rightful possessor of the gift card.

8. A method for exchange of gift cards within a gift card exchange marketplace, the method comprising:
receiving, by a computing device, a request from a gift card holder to exchange at least one first gift card issued by a first merchant, wherein the request includes gift card information;
determining, by a computing device processor, a balance amount remaining on the first gift card based on the gift card information;
determining, by a computing device processor, one or more gift card exchange options, wherein each option includes at least one available second gift card issued by a second merchant and a balance amount remaining on the second gift card, wherein the options are determined based on the balance amount remaining on the first gift card and an exchange rate between the first gift card and the second gift card;
receiving, by a computing device, a selection, from the gift card holder, of one of the options;
in response to receiving the selection, validating, by a computing device processor, that the balance amount remaining on the second gift card associated with the selected option is currently available; and
in response to validating the balance amount on the second gift card, retaining redemption rights in the exchanged first gift card and communicating to the gift card holder information associated with the selected second gift card, which allows the gift card holder to redeem the selected second gift card.

9. The method of claim 8, further comprising filtering, by a computing device processor, the gift card exchange options based on a current location of the gift card holder.

10. The method of claim 8, further comprising filtering, by a computing device processor, the gift card exchange options based on receipt of gift card holder filter criteria.

11. The method of claim 10, further comprising filtering, by a computing device processor, the gift card exchange options based on receipt of gift card holder filter criteria, wherein the criteria includes at least one of a preferred merchant, a preferred merchant type, or maximizing exchange rate.

12. The method of claim 8, further comprising determining, by a computing device processor, a dynamic exchange rate between the first gift card and the second gift card based on a current supply and demand of the first gift card and the second gift card within the gift card exchange marketplace.

13. The method of claim 8, wherein determining the balance remaining on the first gift cards further comprises accessing, by a computing device processor, a gift card validation network associated with the first merchant to determine the balance remaining on the first gift card.

14. The method of claim 13, wherein accessing the gift card validation network further comprises accessing, by the computing device processor, the gift card validation network to validate that the gift card holder is a rightful possessor of the gift card.

15. The method of claim 8, further comprising receiving, by a computing device, a gift card exchange request from the gift card holder wherein the request defines criteria for a second gift card for which the gift card holder is willing to exchange the first gift card.

16. The method of claim 8, further comprising communicating, via a computing device processor, an alert to the gift card holder when the second gift card meeting the criteria becomes available in the marketplace.

17. A computer program product, the computer program product comprising a non-transitory computer-readable medium having computer-executable instructions to cause a computer to implement the steps of:
receiving a request from a gift card holder to exchange at least one first gift card issued by a first merchant, wherein the request includes gift card information;
determining a balance amount remaining on the first gift card based on the gift card information;
determining one or more gift card exchange options, wherein each option includes at least one available second gift card issued by a merchant other than the first merchant and a balance amount remaining on the second gift card, wherein the options are determined based on the balance amount remaining on the first gift card and an exchange rate between the first gift card and the second gift card;
receiving a selection from the gift card holder of one of the options;
in response to receiving the selection, validating that the balance amount remaining on the second gift card associated with the selected option is available; and
in response to validating the balance amount on the second gift card, retaining redemption rights in the exchanged first card and communicating to the gift card holder information associated with the selected second gift card, which allows the gift card holder to redeem the selected second gift card.

18. The computer program product of claim 17, further comprising computer-executable instructions to cause a computer to implement the further steps of filtering the gift card exchange options based on a current location of the gift card holder.

19. The computer program product of claim 17, further comprising computer-executable instructions to cause a computer to implement the further steps of filtering the gift card exchange options based on receipt of gift card holder filter criteria.

20. The computer program product of claim 19, wherein the step of filtering further comprises filtering the gift card exchange options based on receipt of gift card holder filter criteria, wherein the criteria includes at least one of a preferred merchant, a preferred merchant type, or maximizing exchange rate.

21. The computer program product of claim 17, further comprising computer-executable instructions to cause a computer to implement the further steps of determining a dynamic exchange rate between the first gift card and the second gift card based on a current supply and demand of the first gift card and the second gift card within the gift card exchange marketplace.

22. The computer program product of claim 17, wherein the step of determining the balance remaining on the first gift card further comprises accessing a gift card validation network associated with the first merchant to determine the balance remaining on the first gift card.

23. The computer program product of claim 22, wherein the step of accessing the gift card validation network further comprises accessing the gift card validation network to validate that the gift card holder is a rightful possessor of the gift card.

24. The computer program product of claim 17, further comprising computer-executable instructions to cause a computer to implement the further steps of receiving a gift card exchange request from the gift card holder wherein the request defines criteria for a second gift card for which the gift card holder is willing to exchange the first gift card.

25. The computer program product of claim 24, further comprising computer-executable instructions to cause a computer to implement the further steps of communicating an alert to the gift card holder when the second gift card meeting the criteria becomes available in the marketplace.
